(19) United States
(12) Patent Application Publication
(10) Pub. No.: US 2009/0327268 A1
(43) Pub. Date: Dec. 31, 2009

(54) PROVIDING TARGETED INFORMATION FOR ENTERTAINMENT-ORIENTED SEARCHES

(75) Inventors: JUSTIN DENNEY, Seattle, WA (US); CRISTINA A. COLBY, Seattle, WA (US); JAMES T. CLARK, Duvall, WA (US); AJAY NAIR, Redmond, WA (US); SANAZ AHARI, Seattle, WA (US); RICHARD QIAN, Sammamish, WA (US); SALLY SALAS, Issaquah, WA (US); MAURICIO LOMELIN, Seattle, WA (US); JAMIE BUCKLEY, Redmond, WA (US); JOANNA CHAN, Seattle, WA (US); NICHOLAS E. CRASWELL, Cambridge (GB); TABREEZ GOVANI, Mukilteo, WA (US); TRUNG T. TRAN, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/163,406

(22) Filed: Jun. 27, 2008

(51) Int. Cl. G06F 7/06; G06F 17/30

(52) U.S. Cl. 707/5; 707/3; 707/E17.014; 707/E17.108

(57) ABSTRACT

Systems and methods for providing immediate access to comprehensive information and answers on a set of related search engine results pages for common searches executed in the entertainment domain relating to, for instance, music, musicians, movies and celebrities. Upon receipt of a keyword-based search query, a decision is made regarding what the user actually wanted to see as a search result. This information is then automatically presented in a dedicated region of the keyword search results page, typically with links to more refined information. Upon selection of a link, the refined information is also displayed in a dedicated region of the keyword search results page. In this way, the user does not have to navigate multiple, different user interfaces on a variety of different web sites in order to view the information desired.

### BACKGROUND

Typically, when utilizing a search engine, users desiring to obtain as complete a set of information as possible regarding a particular entertainment-related topic of interest must perform a number of distinct steps. For instance, he or she generally must manually synthesize multiple search query terms to perform multiple queries, follow the resulting links to a myriad of web pages where answers and/or desired information may or may not be located, and negotiate a number of different, and not always intuitive, user interfaces found on these web sites. This process can be very time consuming and may not ultimately provide a complete picture of what the user desires to know.

### BRIEF SUMMARY

Embodiments of the present invention relate to systems and methods for providing immediate access to comprehensive information and answers on a set of related search engine results pages for common searches executed in the entertainment domain relating to, for instance, music, musicians, movies and celebrities. Upon receipt of a keyword-based search query, a decision is made regarding what the user actually wanted to see as a search result. This information is then automatically presented as a summary in a dedicated region of the keyword search results page, typically with links to more refined information. The summary may be presented in conjunction with, or in lieu of, the search results matching the input search query. Upon selection of a link, the refined information is also displayed in a dedicated region of the keyword search results page. In this way, the user does not have to navigate multiple, different user interfaces on a variety of different web sites in order to view the information desired.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary computing system suitable for determining and providing targeted information for entertainment-related search queries, in accordance with an embodiment of the present invention;

FIG. 3 is a flow diagram showing a method for presenting a multiple-source topic summary in a dedicated area of a search engine results page, in accordance with an embodiment of the present invention;

FIG. 4 is an illustrative screen display, in accordance with an embodiment of the present invention, of an exemplary user interface showing an illustrative display of a multiple-source topic summary and traditional search results on a single search engine results page;

FIG. 5 is a flow diagram that shows a method for presenting entity-based links in a dedicated area of a search engine results page, in accordance with an embodiment of the present invention;

FIG. 6 is a flow diagram showing a method for presenting gallery links in a dedicated area of a search engine results page, in accordance with an embodiment of the present invention;

FIG. 7 is an exemplary user interface, in accordance with an embodiment of the present invention, showing an illustrative display of gallery links in a dedicated area of a search engine results page;

FIG. 8 is a flow diagram that shows a method for presenting additional or related instant answers in a dedicated area of a search engine results page, in accordance with an embodiment of the present invention;

FIG. 9 is a flow diagram illustrating a method for presenting audio snippets in a dedicated area of a search engine results page, in accordance with an embodiment of the present invention;

FIG. 10 is a flow diagram that shows a method for presenting song lyrics in a dedicated area of a search engine results page, in accordance with an embodiment of the present invention;

FIG. 11 is a flow diagram showing a method for presenting alternate song versions in a dedicated area of a search engine results page, in accordance with an embodiment of the present invention;

FIG. 12 is a flow diagram that shows a method for presenting information pertaining to related artists/musicians/celebrities in a dedicated area of a search engine results page, in accordance with an embodiment of the present invention; and

FIG. 13 is a flow diagram showing a method for presenting scheduled, local television showings of a particular movie, in a dedicated area of a search engine results page, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems and methods for providing immediate access to comprehensive information and answers on a set of related search engine results pages for common searches executed in the entertainment domain relating to, for instance, music, musicians, movies and celebrities. Upon receipt of a keyword-based search query, a decision is made regarding what the user actually wanted to see as a search result. This information is then automatically presented as a summary in a dedicated region of the keyword search results page, typically with links to more refined information. The summary may be presented in conjunction with, or in lieu of, the search results matching the input search query. Upon selection of a link, the refined information is also displayed in a dedicated region of the keyword search results page. In this way, the user does not have to navigate multiple, different user interfaces on a variety of different web sites in order to view the information desired.

Accordingly, in one embodiment, the present invention provides one or more computer-storage media having computer-executable instructions embodied thereon that, when executed, perform a method for presenting targeted information for entertainment-related search queries. The method comprises receiving an entertainment-related search query input by a user; determining at least one information item other than a search result that the user desires to obtain; and presenting the at least one information item in a dedicated area of a search engine results page.

In another embodiment, the present invention provides method for presenting targeted information for entertainment-related search queries. The method comprises receiving a search query input by a user; determining that the input search query is an entertainment-related search query; determining a plurality of information items other than search results that the user desires to obtain; and presenting at least one of one of the plurality of information items and a hyperlink to information related to one of the plurality of information items in a dedicated area of a search engine results page

In yet another embodiment, the present invention provides one or more computer-storage media having computer-executable instructions embodied thereon that, when executed, perform a method for presenting targeted information items for entertainment-related search queries. The method comprises receiving a search query input by a user; dynamically determining that the input search query is an entertainment-related search query by determining that the input search query contains information related to at least one of musicians, music, movies or celebrities; dynamically determining a plurality of information items other than search results that the user desires to obtain, wherein the plurality of information items comprises one or more of an image, relevant content related to an instant answer, an audio snippet of a particular song, lyrics for a particular song, information related to an alternate version of a particular song, information about at least one of an artist, musician, or celebrity related to a particular first artist, musician, or celebrity, and scheduled local television listings for a particular movie; and presenting at least one of one of the plurality of information items and a hyperlink to information related to one of the plurality of information items in a dedicated area of a search engine results page

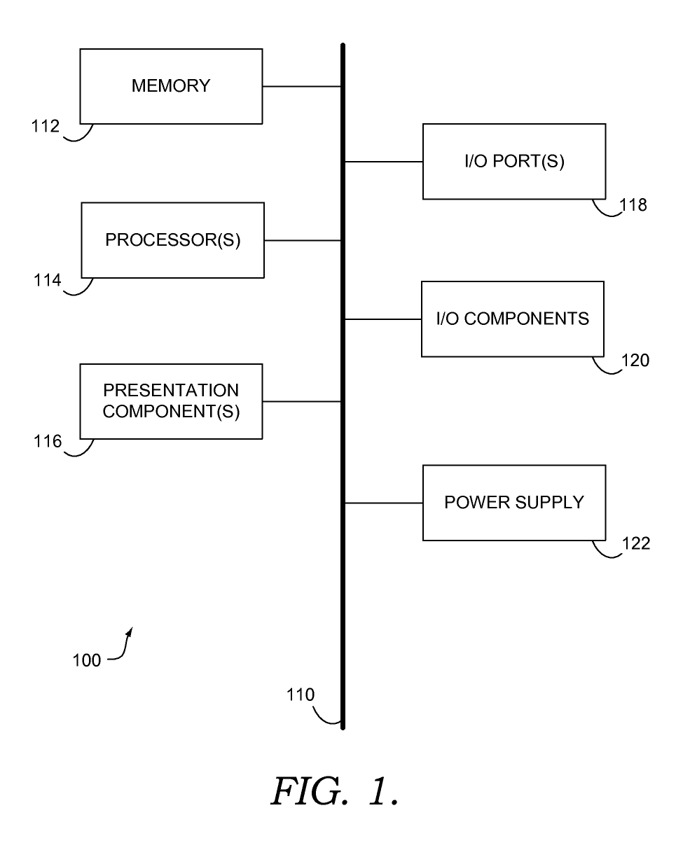

Having briefly described an overview of the present invention, an exemplary operating environment for the present invention is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computer 110 typically includes a variety of computer-readable media. Computer-readable media can be any available media that can be accessed by computer 110 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

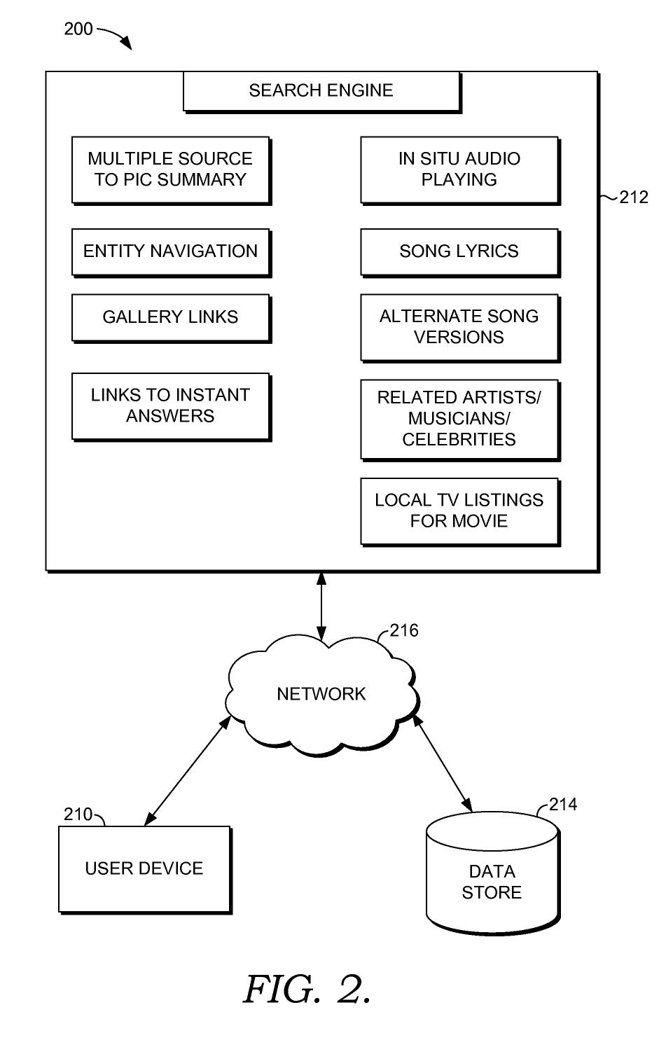

Embodiments of the present invention relate to systems and methods that utilize one or more of a plurality of tools that provide immediate access to comprehensive information and answers on a set of related search engine results pages for common searches executed in the entertainment domain relating to, for instance, music, musicians, movies and celebrities. Turning now to FIG. 2, a block diagram is illustrated, in accordance with an embodiment of the present invention, showing a system 200 configured to determine and provide targeted information for entertainment-related search queries, for instance, search queries related to one or more of music, musicians, movies, and celebrities. It will be understood and appreciated by those of ordinary skill in the art that the system 200 shown in FIG. 2 is merely an example of one suitable computing system environment and is not intended to suggest any limitation as to the scope of use or functionality of embodiments of the present invention. Neither should the system 200 be interpreted as having any dependency or requirement related to any single component or combination of components illustrated therein. Further, the system 200 may be provided as a stand-alone product, as part of a software development environment, or any combination thereof.

The system 200 includes a user device 210, a search engine 212, and a data store 214, all in communication with one another via a network 216. The network may include, without limitation, one or more local area networks (LANs) and/or wide area networks (WANs). Such networking environments are commonplace in offices, enterprise-wide computer networks, intranets and the Internet. Accordingly, the network 216 is not further described herein.

The data store 214 is configured to store information related to entertainment-related search queries. In various embodiments, such information may include, without limitation, images, album information, song information (including audio snippets, lyrics, alternate song versions, related musicians/artists/celebrities, and the like), news stories, television movie listings, popularity information, and the like. In embodiments, the data store 214 is configured to be searchable for one or more of the items stored in association therewith. It will be understood and appreciated by those of ordinary skill in the art that the information stored in the data store 214 may be configurable and may include any information relevant to entertainment-related search queries. The content and volume of such information are not intended to limit the scope of embodiments of the present invention in any way. Further, though illustrated as a single, independent component, data store 214 may, in fact, be a plurality of data stores, for instance, a database cluster, portions of which may reside on the user device 210, the search engine 212, another external computing device (not shown), and/or any combination thereof.

Each of the computing device 210 and the search engine 212 shown in FIG. 2 may be any type of computing device, such as, for example, computing device 200 described above with reference to FIG. 2. By way of example only and not limitation, each of the computing device 210 and the search engine 212 may be a personal computer, desktop computer, laptop computer, handheld device, mobile handset, consumer electronic device, and the like. Additionally, the user device 210 may further include a keyboard, keypad, stylus, joystick, and any other input-initiating component that allows a user to provide wired or wireless data to the network 216, e.g., search queries, web page addresses, and the like. It should be noted, however, that the present invention is not limited to implementation on such computing devices, but may be implemented on any of a variety of different types of computing devices within the scope of embodiments hereof.

Embodiments of the present invention provide various tools that may be utilized by a search engine (for instance, search engine 212), upon receiving a keyword search, to determine what the user really wants to see and present such information in a dedicated area of the search results page. Such information may be presented alone or in addition to the traditional search results, as desired. More particularly, embodiments of the present invention provide tools that may be utilized by a search engine to query or poll a unique combination of data sources and present information obtained there from in a particular, convenient format for users to view. The tools described herein are designed to present a broad spectrum of information to the user and provide the user with the option to further investigate any of the presented information directly from the search engine results page. The tools illustrated in FIG. 2 include multiple source topic summary 218, entity navigation 220, gallery links 222, links to additional instant answers 224, in situ audio playing 224, song lyrics 226, alternate song versions 228, related artists/musicians/celebrities 230, and local television listings for movies 232. Each of these tools is more fully described below.

Presenting Multiple Source Topic Summaries in a Search Engine Results Page

In embodiments, the present invention provides a multiple-source topic summary that presents, in a dedicated area of a search results page, highly relevant information and top-level entry points into a collection of search engine results pages covering a range of topics, with each targeted page containing more focused information

Frequently, search engine users input a simple, general query and subsequently investigate the resulting links for the specific information they actually desire to obtain. As more fully described below, the multiple source topic summary attempts to determine the most likely information the user may be seeking and dynamically assembles a summary of that information, generally with links to high-quality, more targeted information derived from federated data sources. This summary is then presented in a dedicated area of the search engine results page.

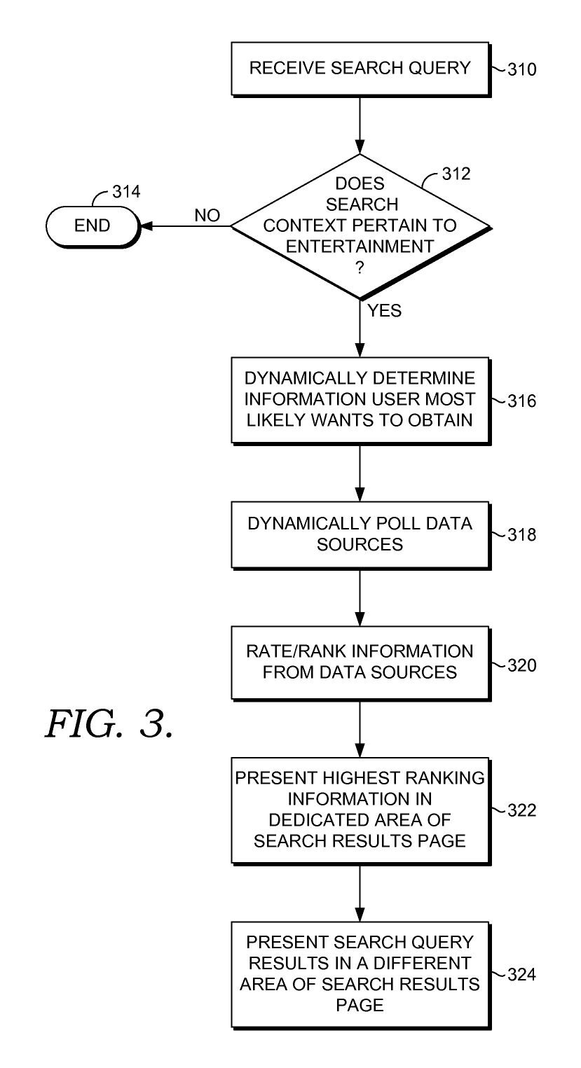

Turning now to FIG. 3, a flow diagram is illustrated that shows a method 300 for presenting a multiple-source topic summary in a dedicated area of a search engine results page, in accordance with an embodiment of the present invention. Initially, as indicated at block 310, a search query input by a user is received. The search query is then analyzed and it is determined whether the search context pertains to entertainment. This is indicated at block 312. If it is determined that the search context does not pertain to entertainment, the method ends as indicated at block 314. If, however, it is determined that the search context does pertain to entertainment, the type of information the user most likely wants to obtain is dynamically determined, as indicated at block 316. Such determination is made, for instance, based upon aggregate past user behavior and the like and includes information types such as, but not limited to, images, video, news, albums, movies, biographies, and the like. The determination regarding the type of information the user most likely wants to obtain is made dynamically, that is, at the particular moment in time the search query is being addressed, and is made on a per-query basis rather than based upon query type. For instance, instead of determining that the same types of information are desired for all celebrity name queries, a unique combination of highly relevant and desired content (e.g., images/news/biographical content) that is specific to the particular celebrity whose name was input as the search query is determined.

Next, as indicated at block 318, disparate data sources are polled to obtain the information determined to be desired. Again, data sources are polled dynamically at the moment in time the search query is being addressed. Thus, the same search query input at two different points in time sufficiently removed from one another may generate different search results. As indicated at block 320, the information obtained from the various data sources is rated/ranked utilizing pre-determined relevance rules and the highest ranking information is presented in a dedicated area of the search results page. This is indicated at block 322. Various relevance rules and methods for ranking information are known to those of ordinary skill in the art and, accordingly, are not further described herein. Any and all such rules and methods may be utilized within embodiments hereof.

In embodiments, the traditional search query results are presented in a distinct area of the search results page that is different from the dedicated area where the high ranking information is presented. This is indicated at block 324. In one embodiment, the dedicated area may be presented vertically near the top of the search results page with the traditional search query results being presented vertically beneath the dedicated area. In another embodiment, the dedicated area may be presented on one horizontal side of the search results page with the traditional search query results being presented on the other horizontal side of the search results page. Any and all such variations, and any combination thereof, are contemplated to be within the scope of embodiments of the present invention.

It should be noted that oftentimes, the information presented in the dedicated area of the search results page will be high-level links to more targeted information. In embodiments, upon user selection of a presented link, the content of the dedicated area will flex to present content associated with the selected link while the remaining content on the search results page will remain unchanged.

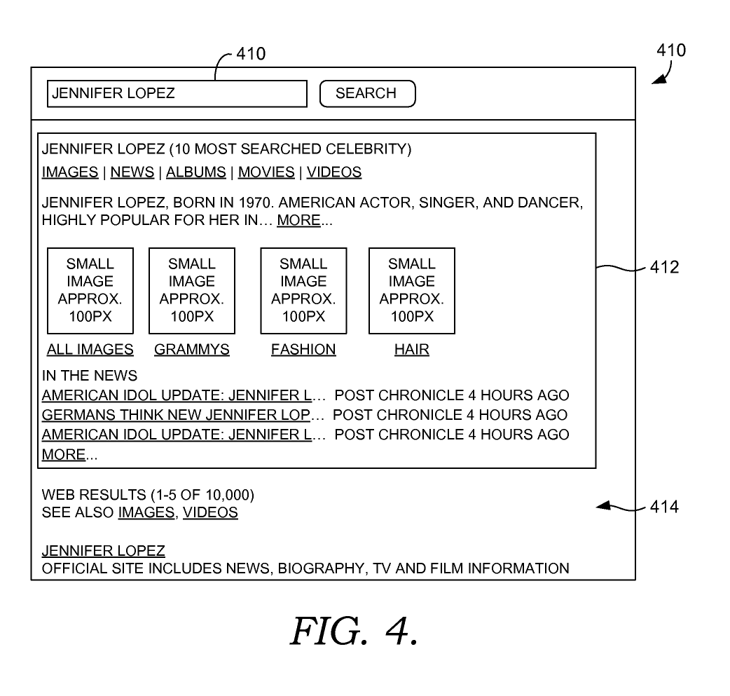

With reference to FIG. 4, an exemplary user interface showing an illustrative display of a multiple-source topic summary and traditional search results on a single search engine results page is shown and designated generally as reference numeral 400. In the illustrated example, the search query input into the search query input box 410 is “Jennifer Lopez”. Upon receipt of the search query, a determination is made that the search context pertains to entertainment and the type of information the user most likely desires to obtain is dynamically determined to be biological information, images and news stories. Various data sources are then polled and the information obtained there from is ranked. The highest ranking information is then presented in a dedicated area of the search engine results page 412. The more traditional search results are also presented in a different area of the search engine results page 414 distinct from the dedicated area 412.

Presenting Navigation Links Pertaining to Entities in a Search Engine Results Page

In embodiments, the present invention provides immediate one-click access to highly relevant information on other search engine results pages for topics directly related to entertainment-related entities (e.g., celebrities or musicians), the particular entity being identified based upon an input search query. Links to the highly-relevant information are dynamically determined and automatically tailored to an input search query.

More particularly, some high-value search terms are associated with multiple contexts. For example, a musician can have personal information, songs, albums, and videos. In embodiments, the present invention detects specific high-value scenarios pertaining to entertainment, identifies an entity or category to which the high-value scenario is related, and displays a set of links related to the identified entity that leads to one or more additional queries with targeted information especially crafted for the scenario. Each entity is a category that has a set of naturally occurring links. Upon identifying what the entity is, the links to be shown are determined. For instance, each entity has a specific type of information associated therewith, such as images or news. If the entity is determined to be a musician, the naturally occurring links that will be shown may be, for instance, songs, albums, videos, and the like. If the entity is a movie star, the naturally occurring links that will be shown may be, for instance, movies, images, biography, etc.

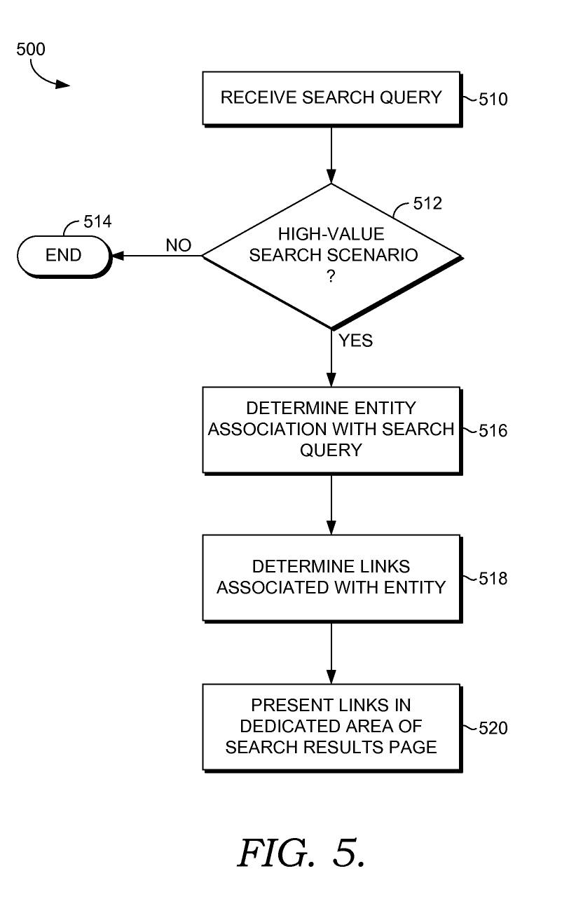

Turning now to FIG. 5, a flow diagram is illustrated that shows a method 500 for presenting entity-based links in a dedicated area of a search engine results page, in accordance with an embodiment of the present invention. Initially, as indicated at block 510, a search query is received. As indicated at block 512, it is next determined if the input search query is an entertainment-related, high-value search scenario, that is, one associated with multiple contexts (e.g., news, images, albums, etc.). If it is determined that the input search query is not indicative of a high-value search scenario, the method ends, as indicated at block 514. If, however, it is determined that the input search query is indicative of a high-value search scenario, the entity to which the input search query belongs is next determined. This is indicated at block 516. Based upon the identified entity, the set of links to be presented are determined, as indicated at block 518. This determination is made dynamically, at the moment the search query is being addressed, so that the determined links lead to information that current data indicates the user most likely desires to obtain at the given time based upon, for instance, aggregate past user behavior. The determined links are then presented in a dedicated area of the search engine results page, as indicated at block 520. Selection of each presented link will navigate the user to targeted information related thereto.

Referring back to FIG. 4, the links “Images”, “News”, “Albums”, “Movies”, and “Videos” are illustrated as displayed near the top of the dedicated area 412 of the search engine results page. Selection of any of the displayed links will lead to more targeted information related thereto.

Presenting Gallery Links in a Search Engine Results Page

In embodiments, the present invention provides links to galleries of images on image search results pages for specific entertainment-related topics (for instance, celebrities or musicians). Each image search results page contains only images related to the specific entertainment-related topic. The topics for each gallery are dynamically determined and assembled at the time a particular input search query is being addressed.

More particularly, when a user submits a search query, they often are interested in investigating closely related information that may not be identified as a direct search result of the input search query. To address this, search engines can determine what the most commonly searched related information is, based upon past aggregate user behavior. In embodiments of the present invention, rather than presenting this related information as a related search on the search engine results page, the presentation of related searches is modified, as more fully described below.

In embodiments of the present invention, related searches are first created by taking a list of queries with the same initial search term and noting the variations. The search term is removed (e.g., “Jennifer Lopez Grammys” becomes simply “Grammys”) leaving just the variation. The terms are ranked based on number of results, adjusting for adult terms and other extraneous factors, if desired. The top N items are then selected and presented as a list of hyperlinks (i.e., gallery links) in a dedicated area of the search engine results page. The underlying URL is formed using query augmentation to create a complete search query for the given subject with refinement. For example, if the user searched for “Jennifer Lopez” and subsequently selected the presented “Grammys” gallery link, the URL would be “search.live.com/results .aspx?x=jennifer+lopez+grammys”.

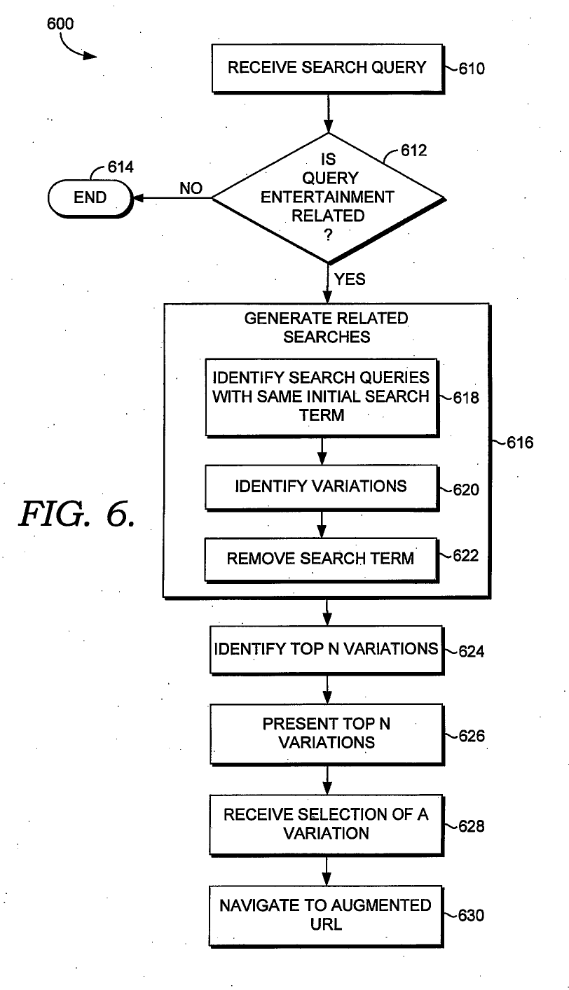

Turning now to FIG. 6, a flow diagram is illustrated that shows a method 600 for presenting gallery links in a dedicated area of a search engine results page, in accordance with an embodiment of the present invention. Initially, as indicated at block 610, a search query is received. Subsequently, as indicated at block 612, it is determined whether the input search query is an entertainment-related query. If it is determined that the input search query is not an entertainment-related search query, the method ends, as indicated at block 614. If, however, it is determined that the input search query is an entertainment-related search query, one or more related searches are generated, as indicated at block 616. The related searches are generated by first identifying, utilizing aggregate past user behavior, a list of search queries with the same initial search term. This is indicated at block 618. Next, as indicated at block 620, variations are identified and the search term is removed leaving only the variation, as indicated at block 622. Next, as indicated at block 624, the top N variations are identified for presentation, wherein N may be any desired number of variations that may be presented. Each of the N variations is then presented as a hyperlink to information (e.g., images) related thereto in a dedicated area of the search engine results page. This is indicated at block 626.

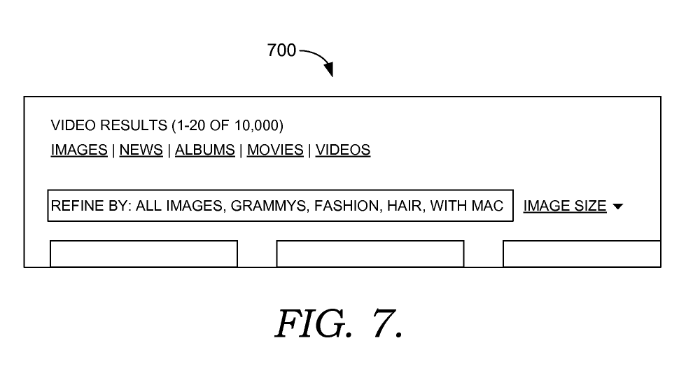

With reference to FIG. 7, an exemplary user interface showing an illustrative display of gallery links in a dedicated area of a search engine results page is shown and designated generally as reference numeral 700. The presented gallery links in the illustrated example are “Grammys”, “Fashion”, “Hair”, and “WithMarc”. Each gallery link represents a hyperlink to images pertaining to the topic indicated by the gallery link title. For instance, selection of the “Grammys” gallery link will navigate the user to Grammy images of the celebrity that was input as a search query and caused display of the user interface 700.

Returning to FIG. 6, selection of one of the displayed hyperlinks is subsequently received, as indicated at block 628. The user is then navigated to a URL defined by query augmentation (complete query in addition to any desired refinements, as described.

Presenting Links to Additional Instant Answers in a Search Engine Results Page

Upon determining with a high degree of confidence that, based upon an input search query, an immediate answer can be provided to a user's question, search engines may present an “instant answer. To see an instant answer, a user must knowingly or inadvertently form their query in such a way to trigger the answer. Typically, if the user wanted to find other instant answers related to the same topic, they would need to form a new query in such a way that would trigger another instant answer.

Embodiments of the present invention identify queries that lend themselves to multiple instant answers, detect additional instant answers related to the current search context, and present hyperlinks that will navigate the user to pages that present the related or additional instant answers. For instance, if a user inputs a search query (e.g., a song title) in the appropriate form that it triggers the presentation of an instant answer related to an artist (e.g., musician that recorded the song identified by the input song title), embodiments of the present invention may determine that, for instance, the album on which the song is recorded may also be desired information. Thus, embodiments of the present invention may also present a link to the additional album instant answer in a dedicated area of the search results page. Upon selection of the album instant answer hyperlink, the user may then be navigated to another page that presents the album title and all other songs recorded thereon.

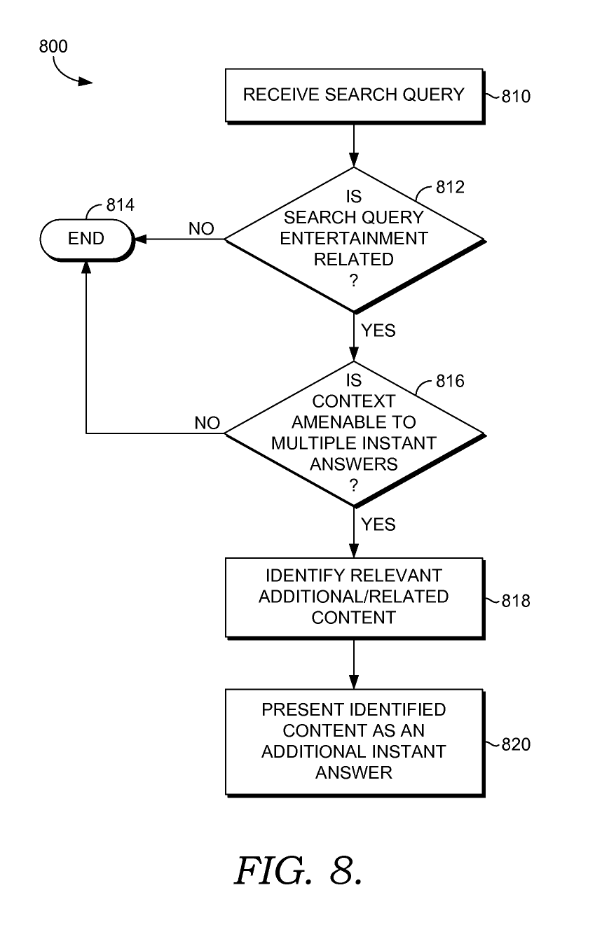

Turning now to FIG. 8, a flow diagram is illustrated that shows a method 800 for presenting additional or related instant answers in a dedicated area of a search engine results page, in accordance with an embodiment of the present invention. Initially, as indicated at block 810, a search query is received. Subsequently, as indicated at block 812, it is determined whether the input search query is an entertainment-related query. If it is determined that the input search query is not an entertainment-related search query, the method ends, as indicated at block 814. If, however, it is determined that the input search query is an entertainment-related search query, it is determined if the context of the input search query is one wherein multiple instant answers may be presented. This is indicated at block 816. If it is determined that the context does not lend itself to multiple instant answers, the method ends, again, as indicated at block 814.

If, however, it is determined that the context of the input search query lends itself to multiple instant answers, a whole page relevance and arbitration methodology (known to those of ordinary skill in the art and not further described herein) is utilized to query a plurality of data sources and identify the most relevant additional or related content. This is indicated at block 818. When a user inputs a query, it is desirable that the whole page presented with the results of the query be related to the query itself. Generally, however, there is far more information than can be displayed on a single page. Accordingly, all of the potential information that may be presented on a page is input into an arbitrator that decides relevance and identifies the most relevant information for presentation. Stated differently, the arbitrator statistically determines the relative relevance of the information and identifies the most likely desired information, i.e., ranks the identified information and identifies the highest-value information. This determined highly-desired information is then presented as an additional “instant answer” in a dedicated area of the search results page, as indicated at block 820. Lower ranking information may still be presented in a different area of the search results page, if desired. The arbitration methodology makes the relevance determination dynamically, taking into account such things as source, ranking, etc. If desired, hyperlinks to other highly relevant available content may be presented as well.

In Situ Audio Playing in a Search Engine Results Page

Embodiments of the present invention provide in situ audio playing, in a search engine results page. This functionality allows a user to play snippets of music related to a current search topic without leaving the search results page.

When searching for audio, users often desire to play a snippet of the music they are searching for to ensure they have found the desired version. In embodiments, the present invention presents a user-activated icon on the search engine results page that, when activated by, plays an audio snippet that is attached to the icon.

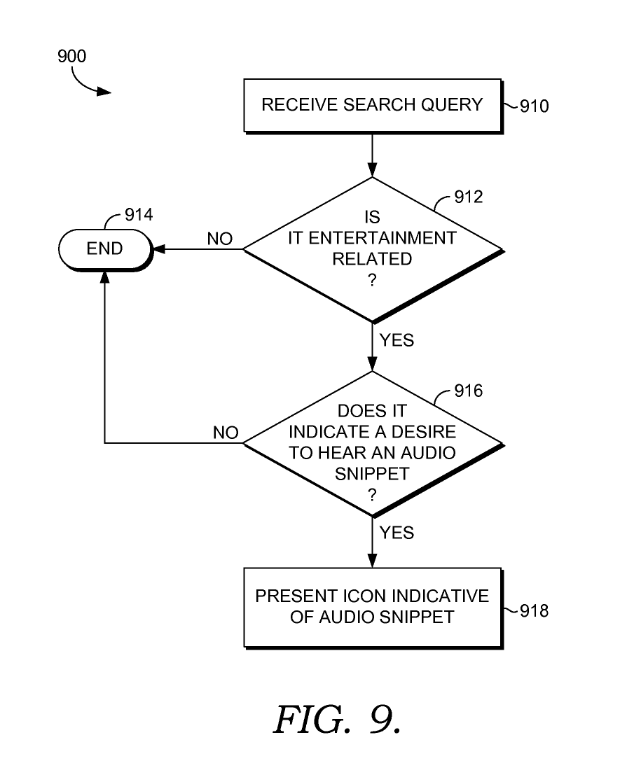

Turning now to FIG. 9, a flow diagram is illustrated that shows a method 900 for presenting audio snippets in a dedicated area of a search engine results page, in accordance with an embodiment of the present invention. Initially, as indicated at block 910, a search query is received. Subsequently, as indicated at block 912, it is determined whether the input search query is an entertainment-related query. If it is determined that the input search query is not an entertainment-related search query, the method ends, as indicated at block 914. If, however, it is determined that the input search query is an entertainment-related search query, it is determined if the input search query is indicative of a desire to hear an audio snippet. This is indicated at block 916. Indicators from the search query that may be indicative of a desire to hear an audio snippet may be, by way of example only, a determination that the query is a song title (or portion thereof), a determination that the query is an album title (or portion thereof), or the like. If it is determined that the context does not indicate a desire to hear an audio snippet, the method ends, again, as indicated at block 914.

Next, an icon indicative of an audio snippet related to the input search query is presented in a dedicated area of the search results page. This is indicated at block 918.

Presenting Song Lyrics in a Search Engine Results Page

Searching for song lyrics is a popular search activity. Generally, if a user inputs a song title or other indication that song lyrics are desired, he or she is presented with a link to a web site, different from the search engine results page, where the lyrics may be found. Embodiments of the present invention provide availability to song lyrics directly on the search engine results page, in a dedicated area thereof, thereby precluding the need to use a third-party service.

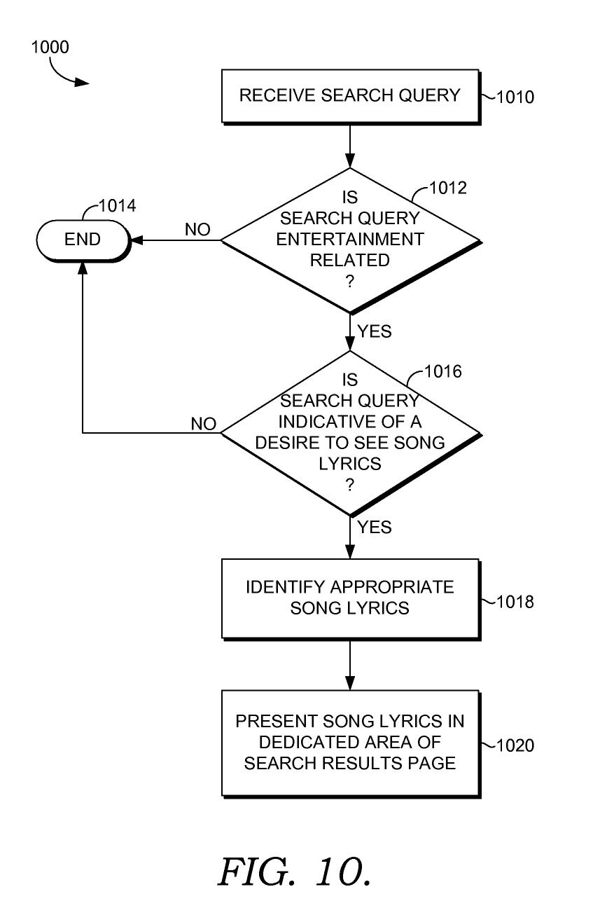

With reference to FIG. 10, a flow diagram is illustrated that shows a method 1000 for presenting song lyrics in a dedicated area of a search engine results page, in accordance with an embodiment of the present invention. Initially, as indicated at block 1010, a search query is received. Subsequently, as indicated at block 1012, it is determined whether the input search query is an entertainment-related query. If it is determined that the input search query is not an entertainment-related search query, the method ends, as indicated at block 1014. If, however, it is determined that the input search query is an entertainment-related search query, it is determined if the input search query is indicative of a desire to see song lyrics. This is indicated at block 1016. Indicators from the search query that may be indicative of a desire to see song lyrics may be, by way of example only, a determination that the query is a song title (or portion thereof), a determination that the query is a portion of a song lyric for a particular song, or the like. If it is determined that the search query is not indicative of a desire to see song lyrics, the method ends, again, as indicated at block 1014.

If, however, it is determined that the search query is indicative of a desire to see song lyrics for a particular song, the appropriate song lyrics are next identified, as indicated at block 1018. Song lyrics may be identified, for instance, by querying a song lyric database utilizing word or character sequences and the like. In embodiments, song lyrics may be obtained in real time from a data file obtained by a feed. Once the appropriate song lyrics are identified, at least a portion thereof is presented in a dedicated area of a search results page, as indicated at block 1020. In embodiments, only a portion of the song lyrics are presented in the search results page initially, in addition to a hyperlink, selection of which will navigate the user to a second search engine details page that presents the complete lyrics. Alternatively, upon selection of the hyperlink, a hidden portion of the web page that contains the remaining lyrics may be presented. Any and all such variations are contemplated to be within the scope of embodiments of the present invention.

Presenting Alternate Song Versions in a Search Engine Results Page

When a user inputs a query indicative of a specific song (e.g., when the query contains a song title (or portion thereof) or song lyric (or portion thereof)), it is likely they may want to discover alternate versions of the song done by the same or another performer. In embodiments, the present invention locates alternate song versions utilizing one or more of song title, lyrics and melody and exposes the alternate song versions as hyperlinks to search results about the alternate versions in a dedicated area of a search results page.

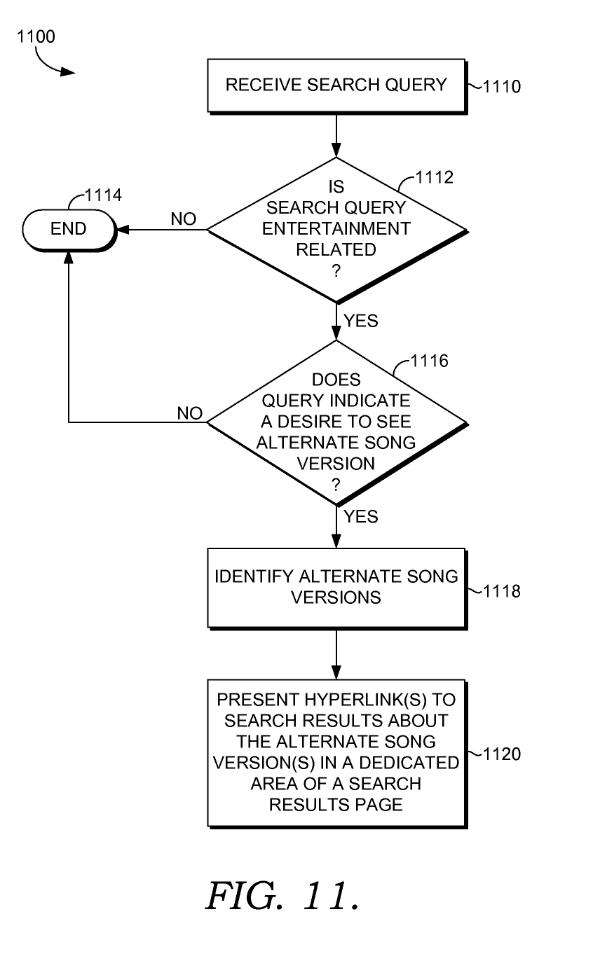

With reference to FIG. 11, a flow diagram is illustrated that shows a method 1000 for presenting alternate song versions in a dedicated area of a search engine results page, in accordance with an embodiment of the present invention. Initially, as indicated at block 1110, a search query is received. Subsequently, as indicated at block 1112, it is determined whether the input search query is an entertainment-related query. If it is determined that the input search query is not an entertainment-related search query, the method ends, as indicated at block 1114. If, however, it is determined that the input search query is an entertainment-related search query, it is determined if the input search query is indicative of a desire to see information pertaining to alternate versions of a particular song. This is indicated at block 1116. Indicators from the search query that may be indicative of a desire to see information pertaining to alternate versions of a particular song may be, by way of example only, a determination that the query is a song title (or portion thereof), a determination that the query is a portion of a song lyric for a particular song, or the like. If it is determined that the search query is not indicative of a desire to see information pertaining to alternate versions of a particular song, the method ends, again, as indicated at block 1114.

If, however, it is determined that the search query is indicative of a desire to see information pertaining to alternate versions of a particular song, alternate song versions are identified, as indicated at block 1118. In embodiments, alternate song versions may be identified utilizing one or more of song title, lyrics and melody. Once identified, hyperlinks to search results about the alternate song versions (e.g., links that, when selected, trigger a re-query for the alternate song version) are presented in a dedicated area of a search results page. This is indicated at block 1120.

Presenting Artists/Musicians/Celebrities Related to a Received Search Query in a Search Engine Results Page

When users input search queries pertaining to entertainment-related persons or entities (e.g., artists, musicians, musical groups, celebrities, and the like), they often desire to obtain information pertaining to other, related musical artists/musicians/celebrities. In embodiments, the present invention determines that an input search query is related to a musician or musical group, determines other artists/musicians/celebrities that are in some way related to the entertainment-related person or entity, and presents hyperlinks that, when selected, navigate the user to information about the related artists/musicians/celebrities.

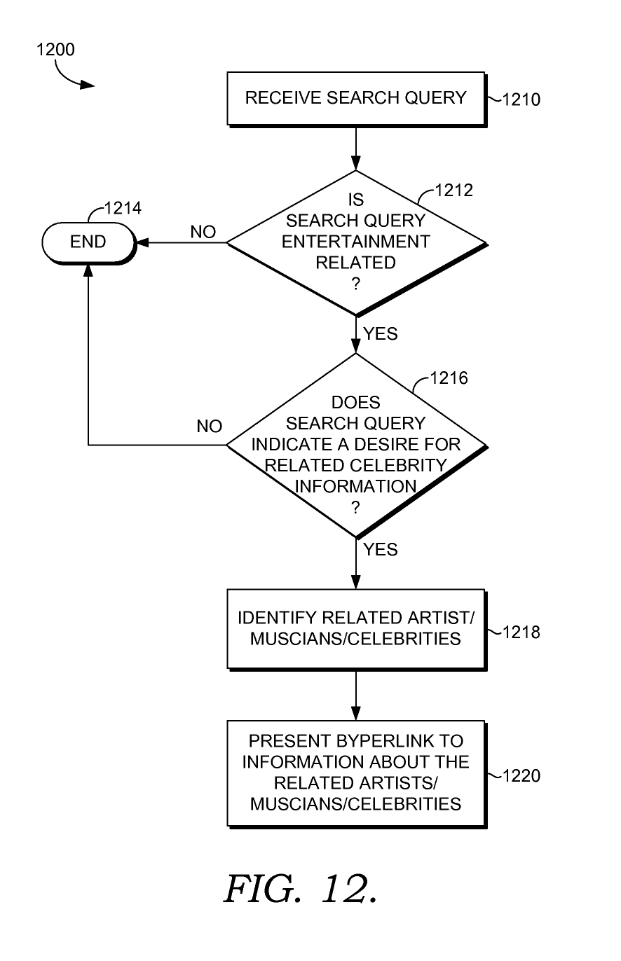

Turning now to FIG. 12, a flow diagram is illustrated that shows a method 1200 for presenting information pertaining to related artists/musicians/celebrities in a dedicated area of a search engine results page, in accordance with an embodiment of the present invention. Initially, as indicated at block 1210, a search query is received. Subsequently, as indicated at block 1212, it is determined whether the input search query is an entertainment-related query. If it is determined that the input search query is not an entertainment-related search query, the method ends, as indicated at block 1214. If, however, it is determined that the input search query is an entertainment-related search query, it is determined if the input search query is indicative of a desire to view information pertaining to related artists/musicians/celebrities. This is indicated at block 1216. Indicators from the search query that may be indicative of a desire to view information pertaining to related artists/musicians/celebrities may be, by way of example only, a determination that the query is the name of a particular artist/musician/celebrity, or the like. If it is determined that the search query is not indicative of a desire to view information pertaining to related artists/musicians/celebrities, the method ends, again, as indicated at block 1214.

If, however, it is determined that the search query is indicative of a desire to view information pertaining to related artists/musicians/celebrities, query logs and other sources are data mined to identify related artists/musicians/celebrities. This is indicated at block 1218. Any identifiable relationship between the artist/musician/celebrity indicated by the input search query and another artist/musician/celebrity, may be utilized to indicate some relationship there between. In embodiments, related artists/musicians/celebrities that link to the same sites as the input artist/musician/celebrity may also be utilized to impute a relationship there between. Once a related artist/musician/celebrity is identified, hyperlinks to search results having information pertaining to the identified related artist/musician/celebrity are presented in a dedicated area of the search results page, as indicated at block 1220.

Presenting Local Television Listings for a Movie in Search Engine Results Page

Once a movie leaves the theaters, it oftentimes is shown on broadcast, cable, and satellite television stations. In embodiments, upon determining that a received search query is or contains the title of a particular movie, the present invention presents local television listings for the movie in a dedicated area of the search engine results page. Such listings may include broadcasts on cable, satellite, or local terrestrial television stations, as desired.

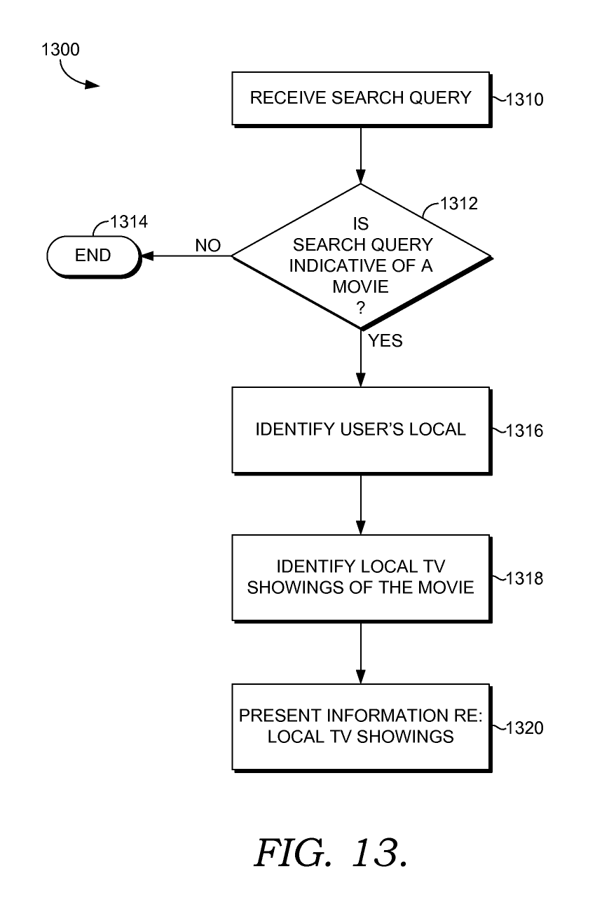

With reference to FIG. 13, a flow diagram is illustrated that shows a method 1300 for presenting scheduled, local television showings of a particular movie, in a dedicated area of a search engine results page, in accordance with an embodiment of the present invention. Initially, as indicated at block 1310, a search query is received. Subsequently, as indicated at block 1312, it is determined whether the input search query is indicative of a particular movie. Indicators from the search query that may be indicative of a particular movie may be, by way of example only, the movie title. If it is determined that the search query is not indicative of a particular movie, the method ends, again, as indicated at block 1314.

If, however, it is determined that the search query is indicative of a particular movie, the user's locale is subsequently determined, as indicated at block 1316. Locale may be detected, for instance, based on the user's Internet provider as generally the user is in the same city as the provider. This can, however, be overridden if the user has provided location information, for instance, if they are looking for information in a locale different from where they are currently located. Next, as indicated at block 1318, local broadcast, cable and/or satellite television showings of the particular movie are identified within a particular time frame (e.g., the current day or the current week). Such information may be identified, for instance, by consulting federated data sources. Information regarding when and where the particular movie is scheduled to be shown in the user's locale is subsequently presented in a dedicated area of the search engine results page. This is indicated at block 1320.

As can be seen, embodiments of the present invention relate to systems and methods for providing immediate access to comprehensive information and answers on a set of related search engine results pages for common searches executed in the entertainment domain relating to, for instance, music, musicians, movies and celebrities. Upon receipt of a keyword-based search query, a decision is made regarding what the user actually wanted to see as a search result. This information is then automatically presented as a summary in a dedicated region of the keyword search results page, typically with links to more refined information. Upon selection of a link, the refined information is also displayed in a dedicated region of the keyword search results page. In this way, the user does not have to navigate multiple, different user interfaces on a variety of different web sites in order to view the information desired

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-storage media having computer-executable instructions embodied thereon that, when executed, perform a method for presenting targeted information for entertainment-related search queries, the method comprising:
receiving an entertainment-related search query input by a user;
determining at least one information item other than a search result that the user desires to obtain; and
presenting the at least one information item in a dedicated area of a search engine results page.

2. The one or more computer-storage media of claim 1, wherein determining at least one information item other than a search result that the user desires to obtain comprises determining that the entertainment-related search query is a high-value search scenario, and wherein presenting the at least one information item comprises presenting at least one hyperlink, selection of which navigates the user to additional queries related to the targeted information.

3. The one or more computer-storage media of claim 1, wherein determining at least one information item other than a search result that the user desires to obtain comprises determining that the user desires to obtain a plurality of images, and wherein presenting the at least one information item comprises presenting a plurality of hyperlinks, each having a plurality of categorized images associated therewith.

4. The one or more computer-storage media of claim 1, wherein determining at least one information item other than a search result that the user desires to obtain comprises determining relevant content related to an instant answer, and wherein presenting the at least one information item comprises presenting the relevant content as an additional instant answer in the dedicated area of the search engine results page.

5. The one or more computer-storage media of claim 1, wherein determining at least one information item other than a search result that the user desires to obtain comprises determining that the user desires to listen to an audio snippet of a particular song, and wherein presenting the at least one information item comprises presenting the audio snippet in a dedicated area of the search engine results page such that selection thereof initiates play of the audio snippet.

6. The one or more computer-storage media of claim 1, wherein determining at least one information item other than a search result that the user desires to obtain comprises determining that the user desires to obtain lyrics for a particular song, and wherein presenting the at least one information item comprises presenting at least a portion of the lyrics for the particular song in the dedicated area of the search engine results page.

7. The one or more computer-storage media of claim 1, wherein determining at least one information item other than a search result that the user desires to obtain comprises determining that the user desires to obtain information related to an alternate version of a particular song, and wherein presenting the at least one information item comprises presenting at least a portion of the information related to the alternate version of the particular song in the dedicated area of the search engine results page.

8. The one or more computer-storage media of claim 1, wherein determining at least one information item other than a search result that the user desires to obtain comprises determining that the user desires to obtain information about at least one of an artist, musician, or celebrity related to a particular first artist, musician, or celebrity, and wherein presenting the at least one information item comprises presenting at least a portion of the information in the dedicated area of the search engine results page.

9. The one or more computer-storage media of claim 1, wherein determining at least one information item other than a search result that the user desires to obtain comprises determining that the user desires to obtain scheduled local television listings for a particular movie, and wherein presenting the at least one information item comprises presenting the scheduled local television listings for a particular movie in the dedicated area of the search results page.

10. A method for presenting targeted information for entertainment-related search queries, the method comprising:
receiving a search query input by a user;
determining that the input search query is an entertainment-related search query;
determining a plurality of information items other than search results that the user desires to obtain; and
presenting at least one of one of the plurality of information items and a hyperlink to information related to one of the plurality of information items in a dedicated area of a search engine results page.

11. The method of claim 10, wherein determining that the input search query is an entertainment-related search query comprises determining that the input search query contains information related to at least one of musicians, music, movies or celebrities.

12. The method of claim 10, wherein determining that the input search query is an entertainment-related search query comprises dynamically determining that the input search query is an entertainment-related search query.

13. The method of claim 10, wherein determining a plurality of information items other than search results that the user desires to obtain comprises determining that that the user desires to obtain a plurality of images, and wherein presenting at least one of one of the plurality of information items and a hyperlink to information related to one of the plurality of information items comprises presenting a plurality of hyperlinks, each having a plurality of categorized images associated therewith.

14. The method of claim 10, wherein determining a plurality of information items other than search results that the user desires to obtain comprises determining relevant content related to an instant answer, and wherein presenting at least one of one of the plurality of information items and a hyperlink to information related to one of the plurality of information items comprises presenting the relevant content as an additional instant answer hyperlink in the dedicated area of the search engine results page.

15. The method of claim 10, wherein determining a plurality of information items other than search results that the user desires to obtain comprises determining that the user desires to listen to an audio snippet of a particular song, and wherein presenting at least one of one of the plurality of information items and a hyperlink to information related to one of the plurality of information items comprises presenting the audio snippet in a dedicated area of the search engine results page such that selection thereof initiates play of the audio snippet.

16. The method of claim 10, wherein determining a plurality of information items other than search results that the user desires to obtain comprises determining that the user desires to obtain lyrics for a particular song, and wherein presenting at least one of one of the plurality of information items and a hyperlink to information related to one of the plurality of information items comprises presenting at least a portion of the lyrics for the particular song in the dedicated area of the search engine results page.

17. The method of claim 10, wherein determining a plurality of information items other than search results that the user desires to obtain comprises determining that the user desires to obtain information related to an alternate version of a particular song, and wherein presenting at least one of one of the plurality of information items and a hyperlink to information related to one of the plurality of information items comprises presenting at least a portion of the information related to the alternate version of the particular song in the dedicated area of the search engine results page.

18. The method of claim 10, wherein determining a plurality of information items other than search results that the user desires to obtain comprises determining that the user desires to obtain information about at least one of an artist, musician, or celebrity related to a particular first artist, musician, or celebrity, and wherein presenting at least one of one of the plurality of information items and a hyperlink to information related to one of the plurality of information items comprises presenting at least a portion of the information in the dedicated area of the search engine results page.

19. The method of claim 10, wherein determining a plurality of information items other than search results that the user desires to obtain comprises determining that the user desires to obtain scheduled local television listings for a particular movie, and wherein presenting at least one of one of the plurality of information items and a hyperlink to information related to one of the plurality of information items comprises presenting the scheduled local television listings for a particular movie in the dedicated area of the search results page.

20. One or more computer-storage media having computer-executable instructions embodied thereon that, when executed, perform a method for presenting targeted information items for entertainment-related search queries, the method comprising:
receiving a search query input by a user;
dynamically determining that the input search query is an entertainment-related search query by determining that the input search query contains information related to at least one of musicians, music, movies or celebrities;
dynamically determining a plurality of information items other than search results that the user desires to obtain, wherein the plurality of information items comprises one or more of an image, relevant content related to an instant answer, an audio snippet of a particular song, lyrics for a particular song, information related to an alternate version of a particular song, information about at least one of an artist, musician, or celebrity related to a particular first artist, musician, or celebrity, and scheduled local television listings for a particular movie; and
presenting at least one of one of the plurality of information items and a hyperlink to information related to one of the plurality of information items in a dedicated area of a search engine results page.
